(19) United States
(12) Patent Application Publication
(10) Pub. No.: US 2015/0200032 A1
(43) Pub. Date: Jul. 16, 2015

(54) LIGHT WEIGHT, HIGH STRENGTH, HIGH CONDUCTIVITY HYBRID ELECTRICAL CONDUCTORS

(71) Applicant: Fisk Alloy Inc., Hawthorne, NJ (US)

(72) Inventor: Joseph Saleh, Morristown, NJ (US)

(73) Assignee: Fisk Alloy Inc., Hawthorne, NJ (US)

(21) Appl. No.: 14/597,533

(22) Filed: Jan. 15, 2015

Related U.S. Application Data
(60) Provisional application No. 61/927,676, filed on Jan. 15, 2014.

(51) Int. Cl. H01B 1/02; H01B 13/02; H01B 5/08

(52) U.S. Cl. CPC H01B 1/023; H01B 1/026; H01B 5/08; H01B 13/0292; H01B 13/0285

(57) ABSTRACT

A hybrid conductor comprising a core section of CCA wire strands and at least one surrounding outer layer of high strength copper alloy of at least 60 ksi and preferably 80 ksi tensile strength, at least 85% IACS conductivity and at least 6% elongation.

### FIELD OF THE INVENTION

The present application relates to cable conductors. The application claims priority from U.S. provisional Ser. No. 61/927,676 filed Jan. 15, 2014.

### BACKGROUND OF THE INVENTION

Conductors are wires used to conduct electricity or signals in a variety of applications from building wire to medical devices to aerospace applications. The most common materials used as a conductor are copper and aluminum. Copper has a higher electrical conductivity relative to aluminum for the same size (volume) wire whereas aluminum has a higher electrical conductivity if the comparison is based on weight. With a density of 8.94 g/cm³ copper is 3.3 times heavier than aluminum with a density of 2.7 g/cm³. Electrical conductivity of copper is 100% IACS (International Annealed Copper Standard) whereas that of aluminum is 61% IACS. Aluminum has a much lower strength and is also prone to corrosion, but both materials have found application as conductors.

Although much stronger than aluminum, the strength of copper may not be adequate for higher demand applications. Copper alloys have been developed and are in use where strength of copper is inadequate for the application. Some of the traditional copper alloys used for higher demand applications have been cadmium-copper (C16200) and cadmium-chromium-copper (C18135). Both of these alloys, however, contain cadmium, a banned element for health and environmental concerns. Cadmium free environmentally friendly alloys (described below) have been developed to replace these alloys.

Copper clad aluminum (CCA) is a conductor with an outer layer of copper and an inner core of aluminum. This product can be produced with different ratios of copper and aluminum, but generally the copper outer layer constitutes 10% or 15% of the overall material by volume. The copper outer layer, while being conductive, provides a protective solderable outer layer for the wire.

Hybrid conductors have been used to obtain improved properties not attainable with a single material. Aluminum conductors steel reinforced (ACSR) are standard conductors used to carry current. Various constructions are in use, which utilize steel element/s at their core to support the aluminum conductor and prevent sagging. Another example of a hybrid conductor is disclosed in U.S. Pat. No. 7,105,740 B2 describing a seven strand conductor constructed with a central strength member surrounded by six strands of nickel plated copper clad aluminum. In both these cases of hybrid construction, the lighter but weaker aluminum or copper clad aluminum is supported by central strong member to increase the overall strength. Other examples of hybrid conductors are shown in U.S. Pat. Nos. 3,164,669 (Meyerhoff, 1965) and 5,483,020 (Hardie, 1996) and published U.S. patent application US2010/0196162 (Cerra 2010).

Copper clad aluminum has been used in the aerospace industry as a conductor in cable form. This material, however, has low strength and break load. In addition, crimping this material is problematic due to the low strength of aluminum. Combining a stronger material with the weaker copper clad aluminum can increase the strength, but at the sacrifice of weight. Hence the gain in strength must be sufficient to justify use of the stronger material.

Conductors are manufactured by twisting several wires together, typically in a geometric fashion. Common constructions consist of 7 or 19 strands. The requirements for such constructions in the aerospace applications are described in the European standard EN 4434, for example. In the seven strands construction six wires are twisted around a central wire. In the nineteen strands construction a third outer layer of twelve wires are wrapped around the seven ends core group of wires. Unilay construction is a common and more economical construction where the six wires of the first layer and the twelve wires of the second layer are wrapped around the central wire at the same time and with the same pitch (lay). Conductors can be manufactured with more than two layers of single end wire twisted around the central wire, but the seven and nineteen strand conductors are common. Preferably all the wires are of the same diameter, often in the ranges of AWG (American Wire Gauge) 30-50 (10 mil to about 1 mil) and typically about 4-5 mils.

U.S. Pat. No. 7,105,740 describes a hybrid conductor of copper clad aluminum with a “strength member”. This seven strand product consists of six strand outer layer of copper clad aluminum surrounding the central strength member. Crimping is applied to the outer soft copper clad aluminum with its complications. New costly contacts, crimping tools and crimping procedures had to be developed for this product to ensure proper crimping protection. The strength member is not described in this patent disclosure.

There has been a trend to reduce weight in many applications. This is especially true in the aerospace and automotive industries which strive to reduce weight in order to increase fuel efficiency. Wire harnesses make up a component of the weight in airplanes. Reducing weight has been a major requirement and a challenge in designing modern planes. Finding lighter conductors has been one of these goals. Tools for crimping the conductors are costly and attempts are made to maintain size to be able to use existing tools. This requires reducing cable conductor weight without changing the cable conductor size so that existing tools can be utilized.

It is a purpose of this invention to provide a solution by reducing the weight of the conductors currently used in the aerospace industry without degrading other attributes including size, break load, elongation or electrical conductivity. Where possible it is a purpose of this invention to additionally increase the strength of the conductor substantially beyond specifications and/or comparable state-of-the-art conductors, to thereby improve performance. Additionally it is a purpose of this invention to allow use of the existing tools for crimping and avoid the need for costly new devices to crimp the conductor.

### SUMMARY OF THE INVENTION

The present invention provides a hybrid conductor of stranded wires with a core group of stranded wires and a second outer layer of stranded wires where the outer layer wires are trade of a strong copper base alloy and the wires of the inner core group layer/layers are wires of the weaker but lighter copper clad aluminum. The combined strength of the two members as a hybrid conductor equals or exceeds the strength of the conductors currently used in the industry while meeting or exceeding other criteria of modern standards exemplified by EN 4434.

Other objects, features and advantages will be apparent from the following detailed description of preferred embodiments taken in conjunction with the accompanying drawings in which:

### BRIEF DESCRIPTION OF THE DRAWINGS

FIG. 1 is a cross section of a conductor according to a preferred embodiment of the present invention; and

FIG. 2 is a cross section view of a conductor with plastic insulation removed to expose wires and crimped in a contact using a typical crimping tool.

### DETAILED DESCRIPTION OF PREFERRED EMBODIMENTS

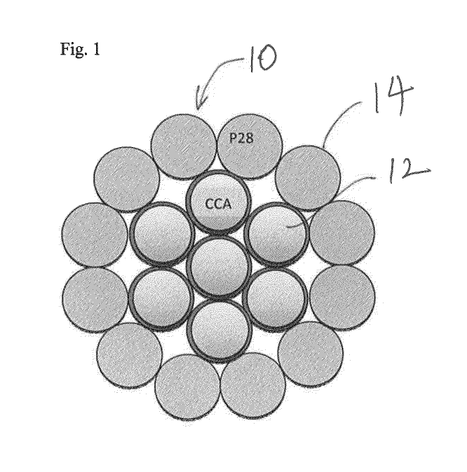

An example of the cable construction is shown in FIG. 1 where a stranded conductor 10 comprising the seven internal wires 12 of copper clad aluminum (CCA) and twelve outer layer wires 14 of an extra-high strength copper alloy, examples of which are given below.

Tables 1 and 2 below list the requirements of the European aerospace industry for tight tolerance nickel plated AWG 26 and AWG 24 conductors. Most aerospace conductors are plated either with silver or nickel. Additionally these conductors require a minimum of 6% elongation.

Choices of the copper alloy wires 14 for an outer ring of wires can include, for example, wires made of the PERCON® 28 (P28) and PERCON® 24 (P24) alloys and made and sold by Fisk Alloy, Inc. The P28 alloy has a minimum of 80 ksi (10³ lbs./in.²) tensile strength, a minimum of 85% IACS conductivity, and a minimum of 6% elongation. The density of P28 is 0.323 lbs/in³. P28 is described in a white paper of Fisk Alloy, Inc: (http://www.fiskalloy/wp-content/uploads/2012/04/percon_{—}28_whitepaper.pdf). P24 alloy is described in U.S. Pat. Nos. 6,053,994 and 6,063,247. It was discovered that it is possible to combine P28 or P24 wires, or other wires of similar properties, with copper clad aluminum in a specific conductor construction to obtain the desired properties of the alloy conductors described in EN 4434 as a whole while saving weight. This applies to base conductors of copper alloy and copper clad aluminum or such conductors as coated with nickel or silver or other metals in customary cable construction practice. The nickel coating thickness is typically specified as 50 μin (in×10⁻⁶) minimum and silver typically in the order of 40 μin minimum. These conductors are typically further over-coated with insulation materials preferably high temperature materials such as polyimides, in one layer or multiple layers.

TABLE 1
Requirements for the Tight Tolerance Nickel
Plated European Aerospace Conductors - Metric

| | | | | DC Resistance, | Break Load, | Weight, |
|---|---|---|---|---|---|---|
| | | Diameter, mm | | Ohms/km | N | kg/km |
| Size | Construction | min | max | max | min | max |
| AWG 26 | 19/38 | 0.47 | 0.49 | 160 | 46 | 1.40 |
| AWG 24 | 19/36 | 0.555 | 0.585 | 114 | 67 | 2.00 |

TABLE 2
Requirements for Tight Tolerance Nickel Plated
European Aerospace Conductor Cables - Imperial

| | | | | DC Resistance, | Break Load, | Weight, |
|---|---|---|---|---|---|---|
| | | Diameter, inch | | Ohms/1000 ft | lbs | lbs/1000 ft |
| Size | Construction | min | max | max | min | max |
| AWG 26 | 19/38 | 0.0185 | 0.0193 | 48.77 | 10.34 | 0.941 |
| AWG 24 | 19/36 | 0.0219 | 0.0230 | 34.75 | 15.06 | 1.344 |

Copper clad aluminum wires usable as wires 12 in the above described conductor are available with various ratios of copper to aluminum. One of the more common and useful ratios is 15% copper (as to overall volume of the material). This is the CCA wire used in the examples shown in this application but the invention is not limited to this ratio of copper and other CCA choices can also be used preferably in the range of 5 to about 30%. Density of 15% copper clad aluminum wires is 0.1312 lbs/in³. Minimum electrical conductivity of this material is 64.4% IACS. Tensile strength of annealed CCA conductors in the diameters of interest (typically less than 0.010″ or 30 AWG) is in the range of 20 to 2.5 ksi (1000 lbs/sq in).

Based on the values for P28 copper alloy wire and CCA wire components, expected properties for the hybrid construction shown in FIG. 1 can be calculated. These results for nickel plated hybrid conductors fitting the size requirements of the European aerospace conductor are shown in Table 3, below. The calculated results indicate that the product will be lighter yet stronger than the standard material currently specified. An AWG 26 conductor so made will be 17% lighter yet 33% stronger compared to the standard while maintaining other attributes such as resistance and elongation. An AWG 24 construction so made will be 20% lighter and 27% stronger compared to the standard.

TABLE 3
Calculated Values for Nickel Plated P28 and CCA Hybrid Conductor Cables

| | | | | DC Resistance, | Break Load, | Weight, |
|---|---|---|---|---|---|---|
| | | Diameter, inch | | Ohms/1000 ft | lbs | lbs/1000 ft |
| Size | Construction | min | max | max | min | max |
| AWG 26 | 19/38 | 0.0188 | 0.0193 | 47.96 | 13.75 | 0.780 |
| AWG 24 | 19/36 | 0.0222 | 0.0227 | 34.57 | 19.08 | 1.075 |

These conductors are required to have a minimum of 6% elongation, they are used in the soft temper and require annealing following the last wire drawing operation. Since the two materials of the two wire types do not have the same softening characteristics they must be annealed at different steps. When CCA wires at smaller diameters, especially smaller than 0.010″ (10 mils), are batch annealed formation of brittle Cu—Al intermetallic results in reduced ductility (elongation) of the wire. Hence, annealing of the CCA wires is conducted by operations Which expose the material to high temperature for only a short time, such as strand (tube) annealing or resistance annealing. The two wire components (copper alloy wires and CCA wires) can either be individually annealed prior to stranding or alternatively the copper alloy wires can be annealed separately and then hard CCA and soft copper alloy wires can be stranded followed by annealing the entire conductor at lower temperatures for annealing the CCA wires to impart elongation. Annealing the whole conductor at finish is a preferred operation to allow the strands of the conductor to relax in place and prevent out of pattern geometry.

Percon® 2.8 with its superior tensile strength is an ideal alloy for outer strand wires 14 to be combined with the CCA wires 12. This fact, however, does not exclude use of other high strength alloys such as Percon® 24. Although Percon® 24 has a lower strength, it is possible to combine Percon® 24 and CCA and obtain the required properties for aerospace applications while saving weight under same likely specifications with advantage over prior art cables used under such specifications.

The requirements for AWG 24 and AWG 26 conductors with silver plating are listed in Tables 4 and 5, below. These requirements are the same as those listed in Table 1 and 2 except for the resistance which is lower due to silver plating as opposed to nickel plating. The silver plated option is used here for demonstration of the concept. Other plating options may also be used.

TABLE 4
Requirements for the Tight Tolerance Silver Plated
European Aerospace Conductor Cables - Metric

| | | | | DC Resistance, | Break Load, | Weight, |
|---|---|---|---|---|---|---|
| | | Diameter, mm | | Ohms/km | N | kg/km |
| Size | Construction | min | max | max | min | max |
| AWG 26 | 19/38 | 0.47 | 0.49 | 149 | 46 | 1.40 |
| AWG 24 | 19/36 | 0.555 | 0.585 | 106 | 67 | 2.00 |

TABLE 5
Requirements for Tight Tolerance Silver Plated
European Aerospace Conductor Cables - Imperial

| | | | | DC Resistance, | Break Load, | Weight, |
|---|---|---|---|---|---|---|
| | | Diameter, inch | | Ohms/1000 ft | lbs | lbs/1000 ft |
| Size | Construction | min | max | max | min | max |
| AWG 26 | 19/38 | 0.0185 | 0.0193 | 45.42 | 10.34 | 0.941 |
| AWG 24 | 19/36 | 0.0219 | 0.0230 | 32.31 | 15.06 | 1.344 |

Calculations for a hybrid conductor comprising Percon® 24 copper alloy wire as a ring of outer strands and copper clad aluminum as a core group as illustrated in FIG. 1 are shown in Table 6. Properties of Percon 24 are 90% IACS minimum electrical conductivity, 64 ksi minimum tensile strength and 6% elongation.

TABLE 6
Calculated Values for Silver Plated P24 and CCA Hybrid Conductors

| | | | | DC Resistance, | Break Load, | Weight, |
|---|---|---|---|---|---|---|
| | | Diameter, inch | | Ohms/1000 ft | lbs | lbs/1000 ft |
| Size | Construction | min | max | max | min | max |
| AWG 26 | 19/38 | 0.0188 | 0.0193 | 43.25 | 11.35 | 0.789 |
| AWG 24 | 19/36 | 0.0222 | 0.0227 | 31.17 | 15.75 | 1.087 |

Table 6 indicates that superior properties and weight saving can be achieved even with Percon 24. A 16% weight saving can be obtained with the AWG 26 construction and 19% weight saving with the AWG 24.

### WORKING EXAMPLE 1

Copper clad aluminum (CCA) wires 12 and Percon® 28 wires 14 were plated with sufficient nickel to provide the minimum plating thickness of 50 μin at the final size for the AWG 24 (19/36, i.e. 19 wire strands, each of AWG 36 diameter) construction. Twelve strands of the P28 were batch annealed to provide a minimum of 6% elongation. These twelve strands of the annealed P28 wires and seven strands of as drawn CCA wires were stranded according to the diagram in FIG. 1 in a tubular strander to a unilay construction. The stranded construction was then strand annealed passing through a tube annealer at 360° C. at 25 meters per minute to obtain a minimum of overall 6% conductor elongation. The obtained properties are listed in the table 7 and meet the requirements listed in Table 2 while reducing the weight by 25%.

TABLE 7
Properties Obtained for a 24 AWG Nickel Plated Hybrid Conductor of CCA and P28

| | | Diameter, | DC Resistance, | Break Load, | Weight, | Elongation, |
|---|---|---|---|---|---|---|
| Size | Construction | inch | Ohms/1000 ft | lbs | lbs/1000 ft | % in 10″ |
| AWG 24 | 19/36 | 0.0224 | 33.96 | 19.4 | 1.00 | 8.2 |

This conductor was crimped using standard crimping tools. Evaluation of the crimp quality in terms of strength and electrical resistance indicated equal to superior performance compared with state-of-the art cables tested. The hardness of the wires 14 relative to the CCA wires 12 affords this crimping amenability.

### WORKING EXAMPLE 2

Copper clad aluminum (CCA) wires and Percon 28 wires (P28) were plated with sufficient nickel to provide the minimum plating thickness of 50 μin at the final size for the AWG 26 (19/38, i.e. 19 wire strands, each of AWG 38 diameter) construction. Twelve strands of the P28 were batch annealed to provide a minimum of 6% elongation. These twelve strands of the annealed P28 wires and seven strands of as drawn CCA wires were stranded according to the diagram in FIG. 1 in a tubular strander to a unilay construction. The stranded construction was then strand annealed through a tube annealer at 360° C. at 25 meters per minute to obtain a minimum of overall 6% conductor elongation. The obtained properties are listed in the table 8 and meet the requirements listed in Table 2 while reducing the weight compared to the standard by 22% while providing a break load exceeding, the standard's minimum required by 26%.

TABLE 8
Properties Obtained for a 26 AWG Nickel Plated Hybrid Conductor of CCA and P28

| | | Diameter, | DC Resistance, | Break Load, | Weight, | Elongation, |
|---|---|---|---|---|---|---|
| Size | Construction | inch | Ohms/1000 ft | lbs | lbs/1000 ft | % in 10″ |
| AWG 26 | 19/38 | 0.0191 | 47.8 | 14.0 | 0.732 | 9.3 |

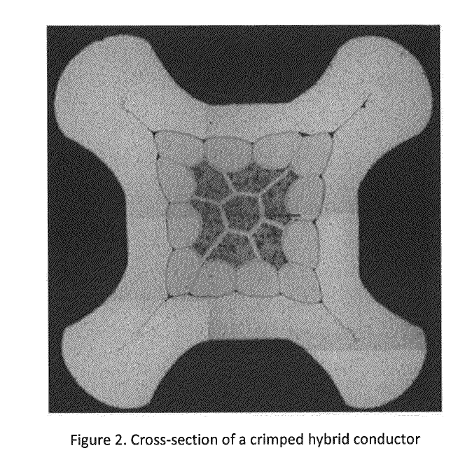

FIG. 2 shows a cross-section view of an end of a conductor 10 with plastic insulation stripped away, the end inserted into a contact and crimped by a conventional crimping tool CT. It is seen that individual wire components 12, 14 of conductor 10 are deformed to close gaps within the conductor and to effect, substantially, a hermetic seal.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1. A hybrid stranded conductor comprising a core group of inner layer/layers wires of copper clad aluminum and one or more outer layers of a high strength copper alloy of at least 60ksi tensile strength, at least 85% IACS conductivity and at least 6% elongation.

2. The hybrid conductor of claim 1, wherein the minimum tensile strength of the high strength copper alloy is at least 80 ksi.

3. The hybrid cable conductor of either of claims 1 or 2 therein the copper clad aluminum wires have 5-30% copper by volume.

4. The hybrid cable conductor of either of claims 1 or 2 wherein the copper clad aluminum wires have at least 10% copper by volume.

5. The hybrid cable conductor of either of claim 1 or 2 wherein the copper clad aluminum wires have at least 1.5% copper by volume.

6. The hybrid cable conductor of either of claim 1 or 2 wherein the copper clad aluminum wires have at least 20% copper by volume.

7. The hybrid cable conductor of either of claims 1 or 2 wherein the copper clad aluminum wires have at least 25% copper by volume.

8. The hybrid cable conductor of either of claim 1 or 2 wherein the copper clad aluminum wires have about 30% copper by volume

9. The hybrid conductor of claim 1 wherein the wire strands of both types are not plated (coated).

10. The hybrid conductor of claim 1 wherein the strands of both types are plated (coated) with nickel or silver.

11. A method of making the conductor of claim 1 or 2 comprising the provision of the component copper clad aluminum wires and high strength copper alloy wires and imposing an anneal/soft tempering step to enhance elongation of the conductor end product by one or more of the steps of:
(a) annealing the copper clad aluminum wires separately before stranding them; and
(b) annealing the copper clad aluminum wires after stranding them with each other and with the copper alloy wires preferably with a short time of exposure to a high temperature to avoid or minimize formation of a copper-aluminum intermetallic compound or alloy therein;
(c) conducting a partial anneal of the copper alloy wires individually or batched prior to stranding, stranding them with each other and with the copper clad aluminum wires to form the conductor, then further heating the conductor for completing anneal of the component wires of both types to achieve the target elongation while avoiding or minimizing intermetallic formation within the copper clad aluminum wires.

12. The conductor of either of claim 1 or 2 with its copper clad aluminum compact wires being substantially free of copper/aluminum intermetallics therein.
